(19) United States
(12) Patent Application Publication
(10) Pub. No.: US 2021/0339815 A1
(43) Pub. Date: Nov. 4, 2021

(54) FOLDING BICYCLE FOR THE TRANSPORT OF INDIVIDUALS AND LOADS

(71) Applicant: DAVID MAURER, EDENKOBEN (DE)

(72) Inventor: DAVID MAURER, EDENKOBEN (DE)

(21) Appl. No.: 17/274,513

(22) PCT Filed: Mar. 12, 2019
(86) PCT No.: PCT/DE2019/100218

§ 371 Date: Mar. 9, 2021

(30) Foreign Application Priority Data
Sep. 11, 2018 (DE) 20 2018 004 202.1
Sep. 12, 2018 (DE) 20 2018 004 221.8
Nov. 22, 2018 (DE) 20 2018 005 369.4

(51) Int. Cl. B62K 15/00; B62K 7/02; B62K 13/08

(52) U.S. Cl. CPC B62K 15/006; B62K 13/08; B62K 7/02

(57) ABSTRACT

A bicycle for transporting loads and individuals, wherein the rear wheel is arranged with a first spacing from the front wheel and wherein the bicycle is constructed to be able to be adjusted in terms of length by the front wheel and/or the rear wheel being able to be moved from a first position into a second position so that the rear wheel and the front wheel in the second position are arranged with a second spacing from each other, wherein the second spacing is greater than the first spacing, and wherein the bicycle both with the first spacing and with the second spacing from the front wheel and rear wheel is ready to ride or can be ridden.

### CROSS-REFERENCE TO RELATED APPLICATIONS

This is a National Stage Application under 35 U.S.C. § 371 of PCT/DE2019/100218, filed on Mar. 12, 2019, which claims priority to German Patent Applications having serial number 202018004202.1, filed on Sep. 11, 2018; number 202018004221.8, filed on Sep. 12, 2018; and number 202018005369.4, filed on Nov. 22, 2018, which are incorporated by reference herein.

### BACKGROUND OF THE INVENTION

### Field of the Invention

The present invention relates to a folding bicycle for transporting individuals and loads.

### Description of the Related Art

In recent years, cargo bikes have become established as an alternative to motor vehicles, in particular in towns, in order to transport loads and/or individuals. Examples of such cargo bikes are the Bakfiets Cargo Bike and the cargo bike from the company Urban Arrow. Cargo bikes from the company Babboe Big have also become widespread.

All these bikes have a relatively high purchase price but are limited in terms of their versatility. These vehicles are also very cumbersome and are not constructed to be able to be disassembled by means of laymen. Consequently, for example, relocation or storage is in most cases difficult.

Thus, for example, with some cargo bikes, channel-like receiving members are used both for the transport of children and for the transport of loads. This can at best be considered to be a compromise solution which falls short of customer expectations both with regard to the safety of the transport of individuals and with regard to the simple ability to be loaded.

Another problem of the cargo bikes in addition to transport is the parking thereof and protection against theft. The known cargo bikes all have the disadvantage that they take up a very large amount of space and consequently cannot be easily parked and secured in the same manner as a normal bicycle.

This makes the cargo bikes impractical and easily accessible for theft since they cannot be stored either in hallways or in cellars and they take up a very large amount of space on roads and pavements. The parking problem exists not only when parking overnight, but also when shopping in the supermarket, at children's nurseries, etcetera.

### SUMMARY OF THE INVENTION

It would therefore be desirable to have a bicycle which can be ridden and parked in the same manner as a normal bicycle, but which so to speak enables the transport of loads.

Consequently, an object of the invention is to provide a cargo bike for transporting loads and/or individuals which enables simple “parking” thereof, wherein it can in particular also be effectively secured against theft.

This object is achieved by a bicycle for transporting loads and individuals, wherein the rear wheel is arranged with a first spacing from the front wheel and wherein the bicycle is constructed to be able to be adjusted in terms of length by the front wheel and/or the rear wheel being able to be moved from a first position into a second position so that the rear wheel and the front wheel in the second position can be arranged or are arranged with a second spacing from each other, wherein the second spacing is greater than the first spacing, and wherein the bicycle both with the first spacing and with the second spacing from the front wheel and rear wheel is ready to ride or can be ridden.

Foldable and collapsible bicycles have been known in the prior art for decades. The surprising recognition of the present invention is that a change of the external dimensions of a bicycle is not only advantageous for transport. The bicycles known from the prior art are folded together in the transport state but cannot be ridden.

As a result of a change of the length of the bicycle, according to the invention it is possible for the first time for a bicycle to be able to provide a great transport range in a flexible manner by the spacing of the front wheel and the rear wheel being able to be changed, wherein the bicycle can be driven with both spacings.

Consequently, the disadvantages of the known cargo bikes are overcome since the bicycle is extended and the receiving range is fully released only when individuals, in particular small children, or objects are intended to be transported, whilst for normal riding or parking the bicycle takes up the external dimensions of a normal bicycle and it can be used and parked accordingly similarly to any conventional bicycle.

In this instance, it may be particularly advantageous for a receiving region for receiving cargo and/or an individual to be released in the second position.

The release of the receiving region is carried out in particular via a rotational movement. The frame of the bicycle according to the invention comprises to this end a first and a second frame portion which are connected to each other at a rotation axle. As a result of a rotational movement, the second frame portion can be moved away with the front wheel or rear wheel from the first frame portion. In this instance, there may in particular be provision when the first and second frame portion move away in a rotational manner for the front wheel or the rear wheel to rotate on the base itself and for the moved frame portion to roll away from the additional frame portion on the wheel.

Consequently, as a result of a simple, even single-handed hand movement, by lifting the bicycle, the bicycle can be moved from the first position into the second position.

It may also be preferable for the rear wheel or the front wheel to be arranged in the first position at least partially in the receiving region for receiving cargo and/or individuals, wherein the receiving region in particular at the lower end thereof has an opening through which the front wheel or the rear wheel can be guided.

Furthermore, there may be provision for the front wheel or the rear wheel to be arranged on an extension arm which is rotatably supported with the bicycle frame so that the rear wheel can be rotatably moved about the rotation axle of the extension arm from the first position into the second position.

There may also be provision for a handle to be arranged in the region of the rotation axle in order to raise the bicycle, wherein in the raised state the rear wheel or the front wheel can thus be moved from the first position into the second position.

Alternatively or additionally, it has been found to be advantageous to lift the bicycle at the saddle in order to move it from the first position into the second position.

It has additionally been found that according to an embodiment of the present invention it is advantageous for the bicycle to comprise pedals which are operationally connected to a force transmission means in order to transfer a rotational pedal movement to the rear wheel.

According to an embodiment of the present invention, it may be particularly advantageous for the force transmission means to be a chain, a cardan shaft and/or an electronic signal transmission which controls an electric drive.

It has been found to be particularly advantageous in this instance for the force transmission means, in particular the chain or the cardan shaft, to be constructed in two parts, wherein the first portion of the force transmission means extends in particular from the pedals up to the rotation axle and the second portion extends from the rotation axle to the front or rear wheel.

It can consequently be ensured that regardless of the position of the driven wheel in the first or second position, a force transmission can be carried out in a reliable manner.

In this instance, it may be preferable for the force transmission means to be constructed in a state divided into two parts, wherein the force transmission means has a force transmission or force redirection location at the rotation axle of the extension arm so that the spacing between the pedal and rotation axle and rotation axle and rear wheel is constant in each case in the first and second positions.

In this instance, it has been found to be particularly advantageous for the force redirection location to comprise a first gear which is operationally connected to the first portion of the force transmission means and a second gear which is operationally connected to the second portion of the force transmission means.

It may also be preferable for the first gear and the second gear to be connected together to the rotation axle of the extension arm, wherein the gears regardless of the rotation axle of the extension arm can be rotated about the extension arm, and wherein the gears are mechanically coupled to each other.

Furthermore, it may be advantageous for the drive to be operationally connected to an electric drive, and wherein the electric drive is operationally connected to an accumulator.

It has also been found to be advantageous according to an embodiment for the electric drive to be arranged between the pedals, at or adjacent to the rotation axle of the extension arm, and/or directly at the rotation axle of the rear wheel, wherein, particularly when the electric drive is arranged at the rotation axle of the extension arm, the arm is mechanically connected to the gear(s) of the force transmission element.

Furthermore, it may be preferable for the receiving region to have a retention member for connecting to a child seat.

Furthermore, it is preferable according to an embodiment for the receiving region to have a foldable closure, comprising two elongate, plate-like elements which, when the front wheel or the rear wheel is moved from the second state into the first state, are opened in an upward direction by the front wheel or the rear wheel and, when the front wheel or the rear wheel is moved from the first state into the second state, are independently closed.

Finally, it may be preferable for the frame of the bicycle to comprise at least 50%, preferably at least 75% aluminum.

The invention also provides for use of a bicycle according to any one of the preceding claims for transporting loads and for riding in the first and the second state.

Other features and advantages of the invention will be appreciated from the following description, in which embodiments of the invention are explained by way of example with reference to schematic drawings without thereby limiting the invention.

### BRIEF DESCRIPTION OF THE DRAWINGS

In the drawings:

FIG. 1: is a perspective view of an embodiment of a bicycle according to the invention in the folded-in state;

FIG. 2: is a side view of the embodiment according to FIG. 1;

FIG. 3: is a partial view of the bicycle according to FIGS. 1 and 2 during the transition from the first position into the second position;

FIG. 4: is a comparison of the embodiment in the first and second positions;

FIG. 5: is a perspective side view of the embodiment in the folded-out state; and

FIG. 6: is a perspective plan view of the embodiment with two-part drive elements in the folded-out state.

### DETAILED DESCRIPTION

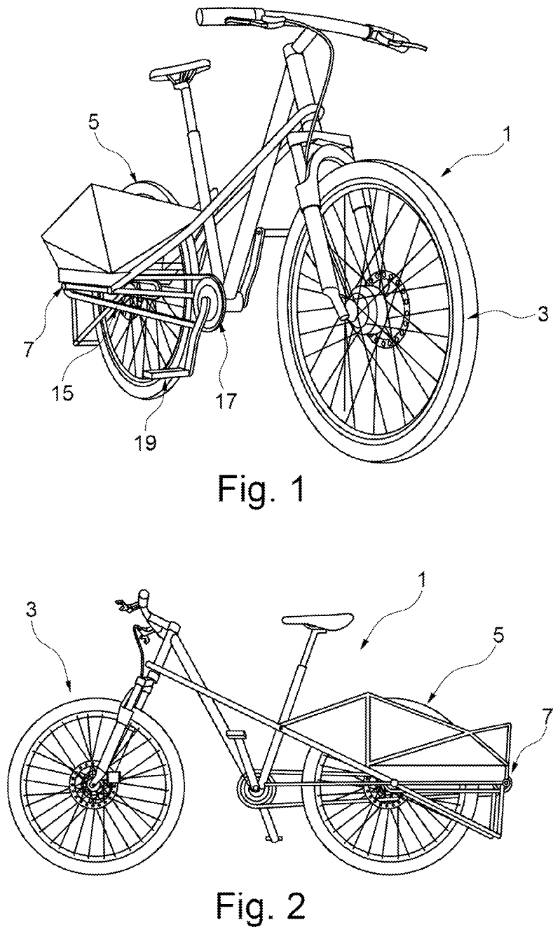

FIGS. 1 and 2 show an embodiment of a bicycle 1 according to the invention for transporting loads and individuals. The bicycle 1 has in this instance a front wheel 3 and a rear wheel 5, wherein the rear wheel 5 is arranged with a first spacing in FIG. 1 from the front wheel 3.

The bicycle 1 is constructed to be longitudinally adjustable by the rear wheel 5 being able to be moved from a first position into a second position so that the rear wheel 5 is arranged in the second position with a second spacing with respect to each other, wherein the second spacing is greater than the first spacing, and wherein the bicycle 1 both with the first spacing and with the second spacing of the front wheel and rear wheel is ready to ride or can be ridden.

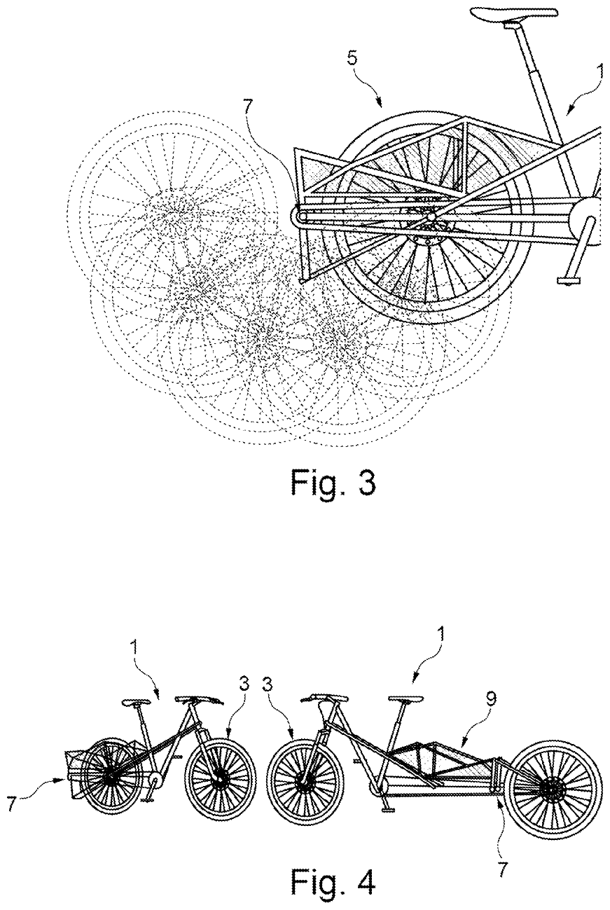

The folded-out bicycle according to the present embodiment is in this instance shown in FIGS. 4, 5 and 6. FIG. 3 shows in this instance the folding-out operation per se, in which the rear wheel rotates about the rotation axle 7.

As a result of the rotation of the rear wheel 5 about the rotation axle 7, in the second position a receiving region 9 for receiving cargo and/or an individual is released.

The release of the receiving region 9 is carried out in this instance via the rotational movement of the rear wheel 5.

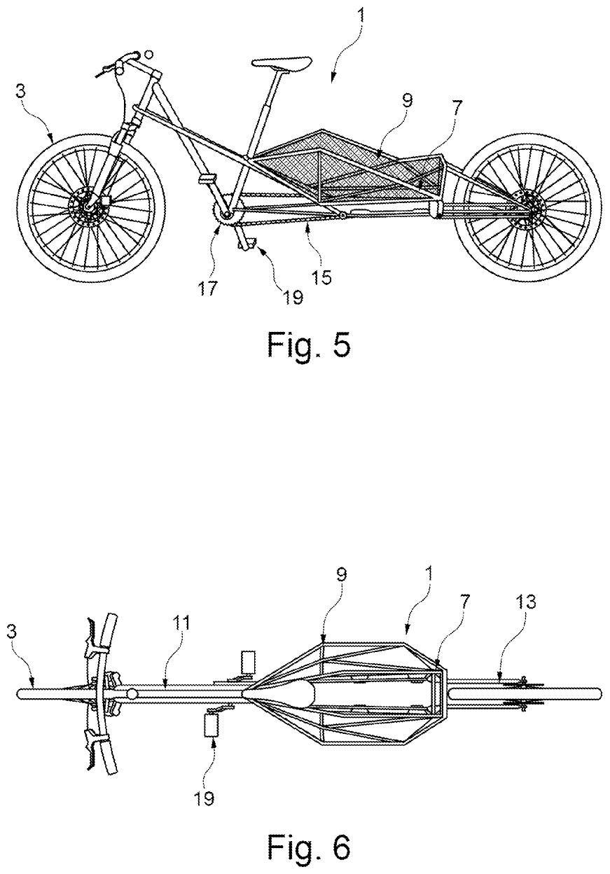

The frame of the bicycle according to the invention comprises for this purpose a first and a second frame portion 11, 13, which are particularly clearly shown in FIGS. 5 and 6 and which are connected to each other at the rotary or rotation axle 7. As a result of a rotational movement, the second frame portion 13 can then be moved away with the rear wheel 5 from the first frame portion 11. In this instance, there may in particular be provision for the rear wheel 5 when moving away in a rotational manner from the first and second frame portions 11, 13 to rotate on the base itself and for the moved frame portion 13 on the rear wheel 5 to roll away from the first frame portion 11. This rotational movement is clearly illustrated in FIG. 3.

Consequently, the bicycle 1 can be moved from the first position into the second position using a simple, even single-handed hand movement by lifting the bicycle 1.

In this instance, the bicycle 1 has a force transmission means 15 in the form of a chain, wherein an electric drive 17 interacts with the pedals 19 as a “central motor”.

The chain 15 is constructed in two pieces in this instance, wherein the first portion of the force transmission means extends from the pedals 19 up to the rotation axle 7 and the second portion extends from the rotation axle 7 to the rear wheel 5.

It can consequently be ensured that, regardless of the position of the driven wheel 5 in the first or second position, a force transmission can be carried out in a reliable manner.

Furthermore, according to an embodiment, it is preferable for the receiving region to have a foldable closure, comprising two elongate, plate-like elements which, when the front wheel or the rear wheel is moved from the second state into the first state, are opened in an upward direction by the front wheel or the rear wheel and, when the front wheel or the rear wheel is moved from the first state into the second state, are independently closed.

Finally, it may be preferable for the frame of the bicycle to comprise at least 50%, preferably at least 75% aluminum.

The invention also provides for use of a bicycle according to any one of the preceding claims for transporting loads and for riding in the first and the second state.

The features of the invention disclosed in the above description, the claims and the drawings may be significant for the implementation of the invention in its various embodiments both individually and in any desired combination.

1. A bicycle for transporting loads and individuals, wherein the rear wheel is arranged with a first spacing from the front wheel and wherein the bicycle is constructed to be able to be adjusted in terms of length by the front wheel and/or the rear wheel being able to be moved from a first position into a second position so that the rear wheel and the front wheel in the second position are arranged with a second spacing from each other, wherein the second spacing is greater than the first spacing, and wherein the bicycle both with the first spacing and with the second spacing from the front wheel and rear wheel is ready to ride or can be ridden.

2. The bicycle of claim 1, wherein a receiving region for receiving cargo and/or an individual is released in the second position.

3. The bicycle of claim 1, wherein a drive acts on the rear wheel or on the front wheel.

4. The bicycle of claim 1, wherein the rear wheel or the front wheel is arranged in the first position at least partially in the receiving region for receiving cargo and/or individuals, wherein the receiving region in particular at the lower end thereof has an opening through which the front wheel or the rear wheel can be guided.

5. The bicycle of claim 1, wherein the front wheel or the rear wheel is arranged on an extension arm which is rotatably supported with the bicycle frame so that the rear wheel can be rotatably moved about the rotation axle of the extension arm from the first position into the second position.

6. The bicycle of claim 1, wherein a handle is arranged in the region of the rotation axle in order to raise the bicycle, wherein in the raised state the rear wheel or the front wheel can thus be moved from the first position into the second position.

7. The bicycle of claim 1, wherein the bicycle comprises pedals which are operationally connected to a force transmission means in order to transfer a rotational pedal movement to the rear wheel.

8. The bicycle of claim 6, wherein the force transmission means is a chain, a cardan shaft and/or an electronic signal transmission which controls an electric drive.

9. The bicycle of claim 6, wherein the force transmission means is constructed in a state divided into two parts, wherein the force transmission means has a force transmission or force redirection location at the rotation axle of the extension arm so that the spacing between the pedal and rotation axle and rotation axle and rear wheel is constant in each case in the first and second positions.

10. The bicycle of claim 9, wherein the force redirection location comprises a first gear which is operationally connected to the first portion of the force transmission means and a second gear which is operationally connected to the second portion of the force transmission means.

11. The bicycle of claim 10, wherein the first gear and the second gear are connected together to the rotation axle of the extension arm, wherein the gears regardless of the rotation axle of the extension arm can be rotated about the extension arm, and wherein the gears are mechanically coupled to each other.

12. The bicycle of claim 1, wherein the drive is operationally connected to an electric drive, and wherein the electric drive is operationally connected to an accumulator.

13. The bicycle of claim 10, wherein the electric drive is arranged between the pedals, at or adjacent to the rotation axle of the extension arm, and/or directly at the rotation axle of the rear wheel, wherein, particularly when the electric drive is arranged at the rotation axle of the extension arm, the arm is mechanically connected to the gear(s) of the force transmission element.

14. The bicycle of claim 1, wherein the receiving region has a retention member for connecting to a child seat.

15. The bicycle of claim 1, wherein the receiving region has a foldable closure, comprising two elongate, plate-like elements which, when the front wheel or the rear wheel is moved from the second state into the first state, are opened in an upward direction by the front wheel or the rear wheel and, when the front wheel or the rear wheel is moved from the first state into the second state, are independently closed.

16. The bicycle of claim 1, wherein the frame of the bicycle comprises at least 50% aluminum or steel.

17. Use of a bicycle for transporting loads and for riding in a first and second state, the bicycle comprising: a rear wheel arranged with a first spacing from the front wheel and wherein the bicycle is constructed to be able to be adjusted in terms of length by the front wheel and/or the rear wheel being able to be moved from a first position into a second position so that the rear wheel and the front wheel in the second position are arranged with a second spacing from each other, wherein the second spacing is greater than the first spacing, and wherein the bicycle both with the first spacing and with the second spacing from the front wheel and rear wheel is ready to ride or can be ridden.
